(19) United States
(12) Patent Application Publication
(10) Pub. No.: US 2012/0326465 A1
(43) Pub. Date: Dec. 27, 2012

(54) SUNSHADE ASSEMBLY WITH LIGHT

(75) Inventor: Thomas E. Harting, Fort Wayne, IN (US)

(73) Assignee: International Truck Intellectual Property Company, LLC, Warrenville, IL (US)

(21) Appl. No.: 13/165,969

(22) Filed: Jun. 22, 2011

(51) Int. Cl. B60J 3/00

(52) U.S. Cl. 296/97.5

(57) ABSTRACT

A sunshade assembly for illuminating an underhood area of a vehicle having an electrical system includes an outer wall forming a sun-blocking surface. The outer wall is mounted to the vehicle. At least one work light is mounted to the outer wall. The at least one work light is constructed and positioned such that the light emitted from the at least one work light is directed at the underhood area to illuminate the underhood area.

### BACKGROUND

Embodiments described herein relate generally to lighting on a vehicle, and more particularly, to lighting of the underhood area of a vehicle.

Commercial truck drivers conduct a daily pre-trip inspection of the vehicle. The underhood area and engine compartment are inspected to check fluid levels, fluid leakage, belt conditions, frayed or broken wires, as well as other component conditions. The underhood area of a commercial vehicle is typically not illuminated. When the inspection is conducted at night or in dark conditions, the truck driver uses a flashlight or other handheld light. However, using a flashlight to light the underhood area can be awkward, particularly during the inspection checks that are two-handed operations, for example checking the fluid levels. When the truck driver uses a flashlight, the underhood inspection becomes a more difficult and less efficient process.

### SUMMARY

A sunshade assembly for illuminating an underhood area of a vehicle having an electrical system includes an outer wall forming a sun-blocking surface. The outer wall is mounted to the vehicle. At least one work light is mounted to the outer wall. The at least one work light is constructed and positioned such that the light emitted from the at least one work light is directed at the underhood area to illuminate the underhood area.

Another sunshade assembly for illuminating an underhood area of a vehicle having an electrical system includes an outer wall forming a sun-blocking surface. The outer wall is mounted to the vehicle. An inner wall is attached to or integrally formed with the outer wall to form an internal chamber. At least one work light is mounted within the internal chamber, where the at least one work light is constructed and positioned such that a majority of the light emitted from the at least one work light is directed at the underhood area to illuminate the underhood area.

A method of illuminating an underhood area of a vehicle having an electrical system includes the step of mounting at least one work light to a sunshade assembly. The work light is positioned such that a majority of the light emitted from the at least one work light is directed at the underhood area to illuminate the underhood area. The method also includes the step of electrically connecting an electrical connection portion of the at least one light to the electrical system of the vehicle.

### BRIEF DESCRIPTION OF THE DRAWINGS

FIG. 1 is a side elevation of a vehicle having an underhood engine compartment and having a sunshade assembly.

FIG. 2 is a perspective view of the sunshade assembly.

FIG. 3 is a cross-section view of the sunshade assembly taken along the line A-A in FIG. 2.

### DETAILED DESCRIPTION

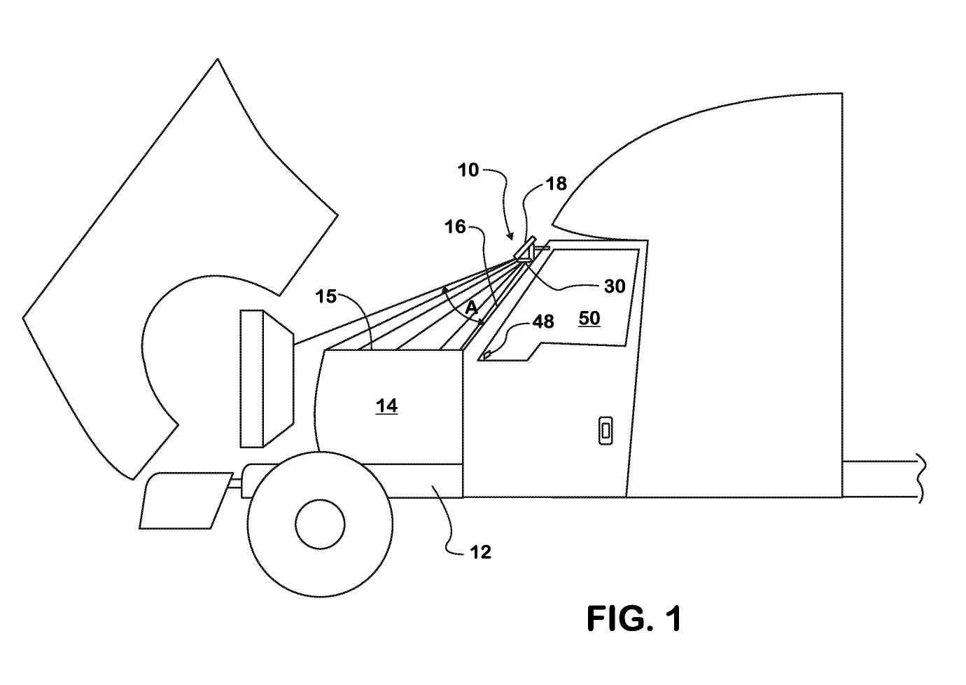

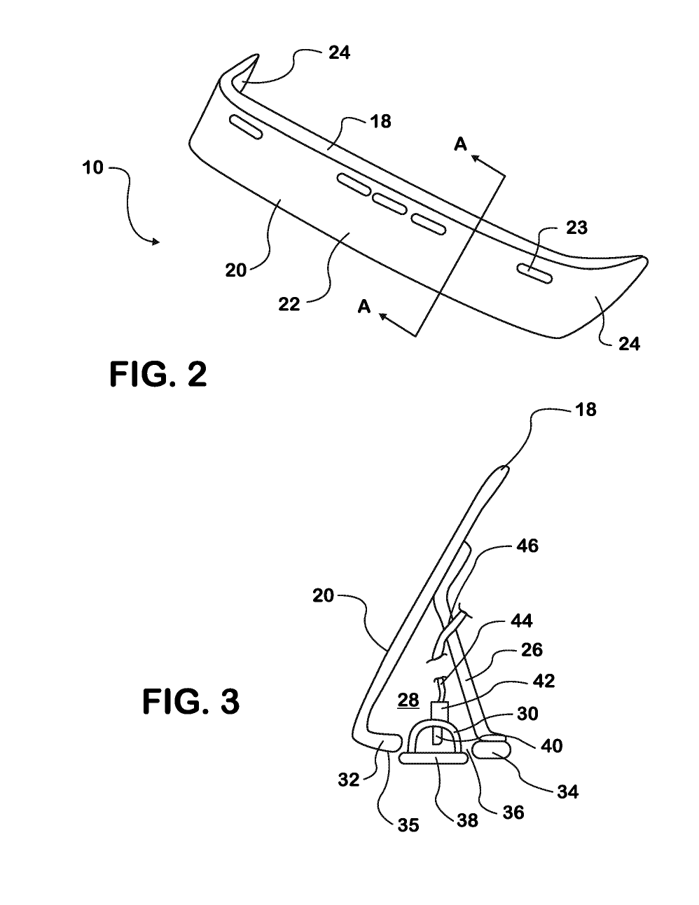

Referring to FIGS. 1-3, a sunshade assembly is indicated generally at 10 and is configured for use on a vehicle 12 having an engine compartment 14 located in an underhood area 15. While the following description will be made with reference to a commercial vehicle 12, it should be appreciated that the sunshade assembly 10 can be incorporated on other types of vehicles.

As is conventionally known, the sunshade assembly 10 is mounted to the vehicle 12 such that the sunshade assembly is positioned generally above and forward from a front windshield 16 of the vehicle. The sunshade assembly 10 may be formed of fiberglass, plastics and metals, such as chrome or stainless steel, among other materials. Further, the style of the sunshade assembly 10 may be a “drop” style, a “louvered” style, a “plain” style, among other styles.

The sunshade assembly 10 includes an outer wall 18 that is configured to provide a sun-blocking surface 20. The outer wall 18 may have a generally elongate portion 22 that extends substantially across the length of the windshield 16, although other lengths are possible. To increase aerodynamic performance characteristics of the vehicle 12, the outer wall may also include two legs 24 that are curved or angled with respect to the elongate portion 22. It is possible that the outer wall 18 may include marking lights 23, such as light emitting diodes (LEDs), on the sun-blocking surface 20 or legs 24. U.S. Government regulations dictate that marking lights 23 are to be amber in color and that marking lights 23 have a forward direction of light emission. As such, the marking lights 23 do not provide sufficient light energy and are not aimed downward in the direction of the underhood area 15 for the purposes of illuminating the underhood area. Instead, the marking lights 23 merely aid in judging clearance between the vehicle 12 and objects in the environment.

An inner wall 26 is attached to or integrally formed with the outer wall 18 to form an internal chamber 28 that houses at least one work light 30 that is for the purposes of illuminating the underhood area 15. The inner wall 26 may extend at an acute angle from the outer wall 18 to form a generally triangular-shaped internal chamber 28 in cross-section, however other shapes are possible. The outer wall 18 may include a lip 32 that is integral with or attached to the sun-blocking surface 20, and that extends towards the inner wall 26. The lip 32 may extend at an acute angle with respect to the sun-blocking surface 20. The inner wall 26 may also include a lip 34 that is integral with or attached to the inner wall, and that extends towards the outer wall 18. The lip 34 may extend at an acute angle with respect to the inner wall 26. The lip 32 and the lip 34 generally enclose the internal chamber 28 and define an opening 36 for receiving the work light 30. In cross-section, the lip 32 and the lip 34 form a third side 35 of the triangular-shaped internal chamber 28, where the inner wall 26 and the outer wall 18 form the first side and second sides, respectively. Alternately, the internal chamber 28 may have any other generally enclosed shape. The opening 36 is in a plane that is generally at an acute angle to the sun-blocking surface 20. The opening 36 is on the third side 35 of the internal chamber 28.

It is possible that one or more work lights 30 are disposed in each opening 36, and that there are one or more openings 36 along the sunshade assembly 10. It is also possible that the work lights 30 may be mounted on the sun-blocking surface 20 of the outer wall 18.

The one or more work lights 30 may be incandescent or LED, with LED having the added benefit of a much longer service life. As such, the work lights 30 may include a lens/bulb 38 and a die/filament 40. The work light 30 may be white light, and may be directed downward at the underhood area 15. The work light 30 is preferably white light, however any other color is possible. Further, the work light 30 may also be a non-amber color. The at least one work light 30 is constructed and positioned such that a majority of the light emitted is directed at the underhood engine compartment to illuminate the underhood area, particularly during inspections. It is possible that the area illuminated A is larger than the underhood area 15, generally the same as the underhood area, or smaller than the underhood area. Further, it is possible that the lens/bulb 38 can be adjusted to focus the light emitted. It is also possible that the work light 30 is mounted to the sunshade assembly 10 to be movable, i.e. to displace or rotate, such that the area illuminated A can be displaced or rotated.

The lens/bulb 38 may be mounted to protrude from the lips 32, 34, may be mounted to be generally flush with the lips, or may be mounted to be recessed from the lips. The one or more work lights 30 may be mounted in the opening 36 such that there are no substantial gaps between work lights and the opening to prevent the exposure of the internal chamber 28 to moisture. In the embodiment of FIG. 3, there is a single work light 30 disposed within each opening 36, and the lens/bulb 38 is generally the same shape and is sized slightly smaller than the opening that the work light is received.

Each of the work lights 30 mounted to the sunshade assembly 10 has an electrical connection portion 42 that is electrically connected to a wire harness 44, which is in turn, connected the electrical system of the vehicle 12 so that electrical power can be provided to the work lights. The wire harness 44 can be used to electrically power each of the work lights 30 in addition to any marking lights 23. In a sunshade assembly 10 with pre-existing marking lights 23, the wire harness 44 is already in place, so there is no need for an additional wire harness, only for an additional power feed wire within the existing harness. The points of connection between the electrical connection portion 42 and the wire harness 44 are concealed within the internal chamber 28. The wire harness 44 may be insulated within the internal chamber 28. It is possible that the outer wall 18 and/or the inner wall 26 may define one or more openings 46 for the wire harness to connect to the electrical system of the vehicle 12.

The work lights 30 can be activated by the operator to provide illumination for conducting pre-trip inspections. It is possible that the operator can activate the work lights 30 with an actuator switch 48 located inside or outside of the vehicle cab 50. It is also possible to integrate the lighting control with other vehicle inputs, such as vehicle speed, gear position, and/or park brake setting, such that the underhood work light 30 is disabled when the vehicle 12 is in motion. Illumination of the work light 30 may only be permitted when the vehicle 12 is not in motion.

By mounting work lights 30 on the sunshade assembly 10, the underhood area 15 of the vehicle 12 can be illuminated with little to no impact on the aerodynamic drag of the vehicle. Further, mounting work lights 30 on the sunshade assembly 10 does not obstruct the view of the driver. Additionally, the sunshade assembly 10 has relatively low vibration compared to other components, such as vehicle hoods, so little vibration is transferred to the work lights 30. Further still, the sunshade assembly 10 typically has a wire harness for the marking light 23, so no additional wire harness is needed for the work light 30.

What is claimed is:

1. A sunshade assembly for illuminating an underhood area of a vehicle having an electrical system, the sunshade assembly comprising:
an outer wall forming a sun-blocking surface mounted to the vehicle;
at least one work light mounted to the outer wall; and
wherein the at least one work light is constructed and positioned such that the light emitted from the at least one work light is directed at the underhood area to illuminate the underhood area.

2. The sunshade assembly of claim 1 further comprising an inner wall that is one of attached to and integrally formed with the outer wall to form an internal chamber that houses the at least one work light.

3. The sunshade assembly of claim 1 wherein the outer wall has a generally elongate portion and two legs that are generally angled with respect to the elongate portion.

4. The sunshade assembly of claim 1 wherein the outer wall includes at least one marking light.

5. The sunshade assembly of claim 1 further comprising a first lip that is one of integral with and attached to the sun-blocking surface, and that extends from the sun-blocking surface at an angle.

6. The sunshade assembly of claim 2 further comprising a second lip that is one of integral with and attached to the inner wall, and that extends from the inner wall at an angle.

7. The sunshade assembly of claim 6 further comprising a first lip that is one of integral with and attached to the sun-blocking surface, and that extends from the sun-blocking surface towards the inner wall.

8. The sunshade assembly of claim 7 wherein the first lip and the second lip enclose the internal chamber and define an opening for receiving the at least one work light.

9. The sunshade assembly of claim 8 wherein the at least one work light includes one of a lens and a bulb mounted to be generally flush with the first lip and the second lip.

10. A sunshade assembly for illuminating an underhood area of a vehicle having an electrical system, the sunshade assembly comprising:
an outer wall forming a sun-blocking surface mounted to the vehicle;
an inner wall that is one or attached to and integrally formed with the outer wall to form an internal chamber; and
at least one work light mounted within the internal chamber, wherein the at least one work light is constructed and positioned such that a majority of the light emitted from the at least one work light is directed at the underhood area to illuminate the underhood area.

11. The sunshade assembly of claim 10 wherein the outer wall has a generally elongate portion and two legs that are generally angled with respect to the elongate portion.

12. The sunshade assembly of claim 10 wherein the outer wall includes at least one marking light.

13. The sunshade assembly of claim 10 further comprising a first lip that is one of integral with and attached to the sun-blocking surface, and that extends from the sun-blocking surface at an angle.

14. The sunshade assembly of claim 13 further comprising a second lip that is one of integral with and attached to the inner wall, and that extends from the inner wall at an angle.

15. The sunshade assembly of claim 14 wherein the first lip and the second lip enclose the internal chamber and define an opening for receiving the at least one work light, wherein the opening is in a plane that is generally at an acute angle to the sun-blocking surface.

16. The sunshade assembly of claim 14 wherein the at least one work light includes one of a lens and a bulb mounted to be generally flush with the first lip and the second lip.

17. The sunshade assembly of claim 10 wherein the at least one work light has an electrical connection portion that is electrically connected to a wire harness that is connected to the electrical system of the vehicle.

18. The sunshade assembly of claim 10 wherein the internal chamber is generally triangular-shaped in cross-section, wherein the at least one work light is mounted on a third side of the triangular-shaped internal chamber.
